(19) United States
(12) Patent Application Publication
(10) Pub. No.: US 2023/0025888 A1
(43) Pub. Date: Jan. 26, 2023

(54) BLUETOOTH PROGRAMMABLE LED SIGN

(71) Applicant: Joseph K. Liu, San Juan Capistrano, CA (US)

(72) Inventor: Joseph K. Liu, San Juan Capistrano, CA (US)

(21) Appl. No.: 17/872,961

(22) Filed: Jul. 25, 2022

Related U.S. Application Data
(60) Provisional application No. 63/225,511, filed on Jul. 25, 2021.

(51) Int. Cl. G09F 9/33; G09F 21/04; G09G 3/20; G09G 3/32

(52) U.S. Cl. CPC G09F 9/33; G09F 21/0485; G09G 3/2096; G09G 3/32; G09F 21/042; G09G 2354/00; G09G 2380/10

(57) ABSTRACT

The subject matter contained herein relates to a programmable electronic display that can be controlled by a mobile device, such as a cell phone. Said display is configured to be placed for view outside a vehicle, such as the rear window of a car or a truck bed gate or on top of the roof of a car.

### CROSS-REFERENCE TO RELATED APPLICATIONS

This application claims priority to U.S. Provisional Application Ser. No. 63/225,511, filed Jul. 25, 2021, which is hereby expressly incorporated by reference in its entirety for all purposes.

### FIELD OF INVENTION

The subject matter described herein relates to programmable LED sign that can be controlled by mobile device via Bluetooth.

### BACKGROUND

Placing personal messages on the back of a vehicle is common. For example, a family of four may place a sticker on the back of an SUV showing that there are children in the car. Sometimes, the goal is to remind people driving behind them to be safe. There are also electronic signs that can be programmable, usually to advertise a phone number or a business advertisement.

But, stickers are static. Even the programmable signs either require a connection to a PC to change the message or a clumsy remote control.

What's described here is an improvement over existing stickers and signs that can be particularly helpful for safety.

### SUMMARY

The subject matter contained herein relates to a programmable electronic display that can be controlled by a mobile device, such as a cell phone. Said display is configured to be placed for view outside a vehicle, such as the rear window of a car or a truck bed gate or on top of the roof of a car.

### BRIEF DESCRIPTION OF THE DRAWINGS

The details of the subject matter set forth herein, both as to its structure and operation, may be apparent by study of the accompanying figures, in which like reference numerals refer to like parts. The components in the figures are not necessarily to scale, emphasis instead being placed upon illustrating the principles of the subject matter. Moreover, all illustrations are intended to convey concepts, where relative sizes, shapes and other detailed attributes may be illustrated schematically rather than literally or precisely.

FIG. 1 is a view of a messaging system in accordance with a preferred embodiment of the present invention.

FIG. 2 is a view of a messaging system installed in a vehicle.

FIG. 3 is a view of another messaging system installed on a vehicle.

FIG. 4 is a view of the components of said messaging systems.

FIG. 5 is a view of a mobile device with a user interface to control the content of said messaging systems.

### DETAILED DESCRIPTION

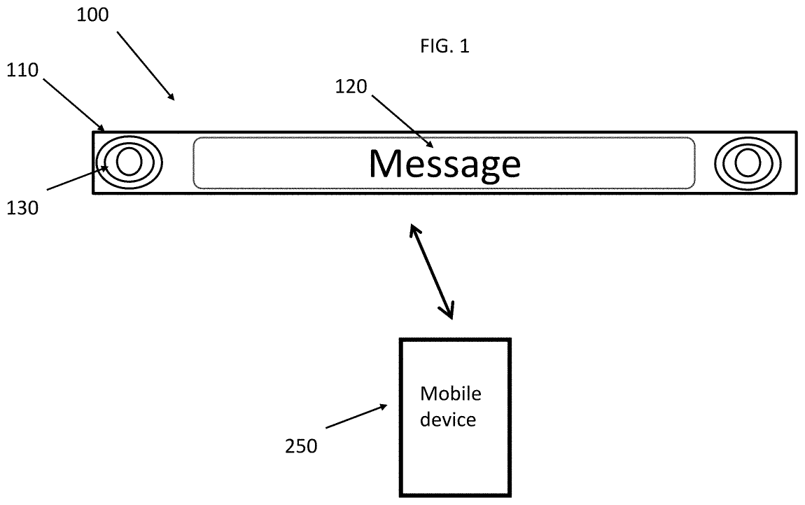

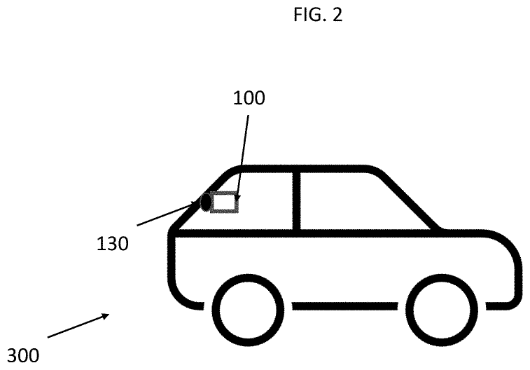

Described herein is a programmable messaging panel 100. Turning to FIG. 1, panel 100 includes a case 110 that houses a plurality of LED lights 120 that are programmable to display a message or graphic. The panel case 110 includes suction device 130 or some sort of attachment mechanism such as tape, glue, or other known forms of attachment. The suction device 130 is configured and positioned to attach to the inside of the rear window of a vehicle 300 such that LED lights 120 face said window, as shown in FIG. 2. The panel 100, within the case 110, includes the programmable LED message panel 120 coupled to a controller 160, which controls the settings of the LED panel 120, such as color, brightness, actual message or graphic, etc. . . . Panel 100 also includes power supply 150, which may be battery, or connection to automobile 300 power source and/or solar panel (not shown.). Alternatively, panel 100 could also include Heads Up Display (“HUD”) technology, including any transparent lighting. In yet another alternative, panel 100 could be integrated into a window of a vehicle, such as the side or rear window of a vehicle, with LED lighting and/or HUD.

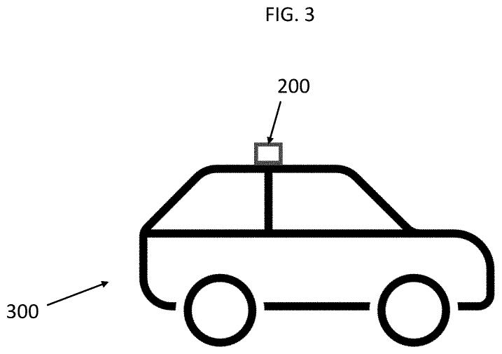

The location of the panel 100 can generally be placed anywhere on the vehicle 300 that enables other cars and pedestrians outside the vehicle 300 to view the content of the panel 100. This can include placing panel 100 on top of a car with anchors or magnetics, similar to a sign one would typically see on a taxi with advertisement. Turning to FIG. 3, another messaging panel 200 is shown. The components are similar to that of panel 100 but includes display lighting 120 on multiple sides of panel 200 (not shown). For instance, panel 200 can include display lighting 120 on the left side, right side, front side, and/or back side of panel 200 or panel 200 can be cylindrical, thereby having a 360° display lighting 120. In yet another embodiment, panel 100 could be placed anywhere on the rear of vehicle 300, such as the rear bumper or the back of a truck bed gate in the case where vehicle 300 is a truck.

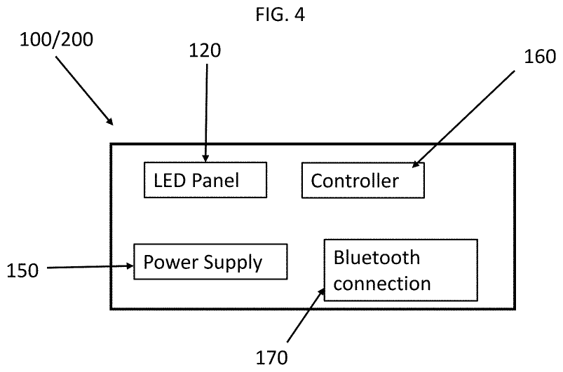

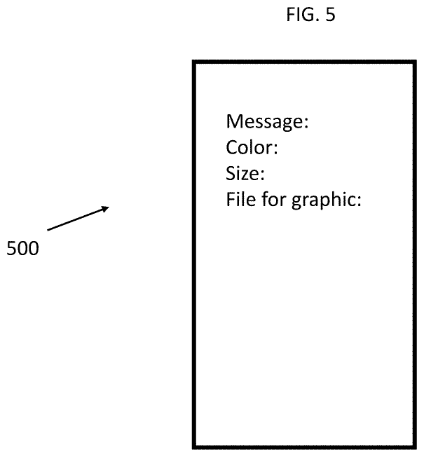

Turning to FIG. 4, the panel 100/200 further includes a wireless communication transceiver, which is preferably Bluetooth, or similar form of wireless communication enabled directly between two devices. A mobile device 250, such as a wireless phone and/or tablet, includes an application configured to discover and communicate with panel 100/200 via Bluetooth connection 170 and controller 160. The messaging panel 100 or 200 contains programmable LED lights 120 allowing a personal/customizable message, in texts and/or in graphics. Turning to FIG. 5, a sample interface 500 is shown on mobile device 250 to control panel 100/200.

When connected, mobile device 250 can be used to control message on panel 100/200. User can either use the mobile device 250 keyboard on the screen or use current voice recognition applications for handsfree programming.

This device can be an invaluable tool while driving. There are many occasions where a driver may observe an unsafe situation. For example, perhaps a driver sees another driver during the night without headlights on. This can happen if the streetlamps are bright enough to make a driver forget to turn on headlights. There's no current way to communicate with such a driver. One can honk or flash lights, but neither effectively communicate more than just getting attention, which can also negatively be viewed as aggressive.

With this device 100/200, a driver can use mobile device 250, pair it with panel 100/200 and add a message, such as “your headlights are off!, or “gas tank lid open” or “sorry” if driver made a mistake to diffuse situation.

Before the present subject matter is described in detail, it is to be understood that this disclosure is not limited to the particular embodiments described, as such may, of course, vary. It is also to be understood that the terminology used herein is for the purpose of describing particular embodiments only, and is not intended to be limiting, since the scope of the present disclosure will be limited only by the appended claims.

As used herein and in the appended claims, the singular forms “a,” “an,” and “the” include plural referents unless the context clearly dictates otherwise.

Throughout this disclosure, the preferred embodiment and examples illustrated should be considered as exemplars, rather than as limitations on the present inventive subject matter, which includes many inventions. As used herein, the term “inventive subject matter,” “system,” “device,” “apparatus,” “method,” “present system,” “present device,” “present apparatus” or “present method” refers to any and all of the embodiments described herein, and any equivalents.

It should also be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

When an element or feature is referred to as being “on” or “adjacent” to another element or feature, it can be directly on or adjacent the other element or feature or intervening elements or features may also be present. In contrast, when an element is referred to as being “directly on” or extending “directly onto” another element, there are no intervening elements present. Additionally, when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Furthermore, relative terms such as “inner,” “outer,” “upper,” “top,” “above,” “lower,” “bottom,” “beneath,” “below,” and similar terms, may be used herein to describe a relationship of one element to another. Terms such as “higher,” “lower,” “wider,” “narrower,” and similar terms, may be used herein to describe angular relationships. It is understood that these terms are intended to encompass different orientations of the elements or system in addition to the orientation depicted in the figures.

Although the terms first, second, third, etc., may be used herein to describe various elements, components, regions, and/or sections, these elements, components, regions, and/or sections should not be limited by these terms. These terms are only used to distinguish one element, component, region, or section from another. Thus, unless expressly stated otherwise, a first element, component, region, or section discussed below could be termed a second element, component, region, or section without departing from the teachings of the inventive subject matter. As used herein, the term “and/or” includes any and all combinations of one or more of the associated list items.

The terminology used herein is for the purpose of describing particular embodiments only and is not intended to be limiting. As used herein, the singular forms “a,” “an,” and “the” are intended to include the plural forms as well, unless the context clearly indicates otherwise. For example, when the present specification refers to “an” assembly, it is understood that this language encompasses a single assembly or a plurality or array of assemblies. It will be further understood that the terms “comprises,” “comprising,” “includes,” and/or “including” when used herein, specify the presence of stated features, integers, steps, operations, elements, and/or components, but do not preclude the presence or addition of one or more other features, integers, steps, operations, elements, components, and/or groups thereof.

Embodiments are described herein with reference to view illustrations that are schematic illustrations. As such, the actual thickness of elements can be different, and variations from the shapes of the illustrations as a result, for example, of manufacturing techniques and/or tolerances are expected. Thus, the elements illustrated in the figures are schematic in nature and their shapes are not intended to illustrate the precise shape of a region and are not intended to limit the scope of the inventive subject matter.

The foregoing is intended to cover all modifications, equivalents and alternative constructions falling within the spirit and scope of the invention as expressed in the appended claims, wherein no portion of the disclosure is intended, expressly or implicitly, to be dedicated to the public domain if not set forth in the claims. Furthermore, any features, functions, steps, or elements of the embodiments may be recited in or added to the claims, as well as negative limitations that define the inventive scope of the claims by features, functions, steps, or elements that are not within that scope.

What is claimed is:

1. A message panel comprising:
a case housing a light-based programmable panel;
an attachment device coupled to the case configured to attach the case to a vehicle such that the light-based programmable panel faces outwards of the vehicle, viewable to pedestrians and other vehicles;
a controller within the case and coupled to the light-based programmable panel to control content on said light-based programmable panel;
a Bluetooth device coupled to the controller, wherein the Bluetooth device is configured to wirelessly receive data from a mobile device with commands to the controller to dictate content on the light-based programmable panel.

2. The message panel of claim 1, wherein the message panel is configured to attach to a rear window of an automobile.

3. The message panel of claim 1, wherein the light-based programmable panel is LED based.

4. The message panel of claim 1, wherein the mobile device is a cellular phone or tablet.
